(19) United States
(12) Patent Application Publication
(10) Pub. No.: US 2010/0216948 A1
(43) Pub. Date: Aug. 26, 2010

(54) POLYMER MIXTURES COMPRISING POLYMERS HAVING DIFFERENT NON-REPEATING UNITS AND METHODS FOR MAKING AND USING SAME

(76) Inventor: Arthur J. Tipton, Homewood, AL (US)

Correspondence Address: Ballard Spahr LLP, SUITE 1000, 999 PEACHTREE STREET, ATLANTA, GA, 30309-3915, US

(21) Appl. No.: 12/692,020

(22) Filed: Jan. 22, 2010

Related U.S. Application Data
(60) Provisional application No. 61/146,973, filed on Jan. 23, 2009.

(51) Int. Cl. C08L 67/04

(52) U.S. Cl. 525/415

(57) ABSTRACT

Described herein are polymer mixtures comprising polymers have at least one different non-repeating unit. Methods for making and using the polymer mixtures are also disclosed. Also disclosed are uses of the polymer mixtures, including methods for making microparticles from the polymer mixtures.

### CROSS-REFERENCE TO RELATED APPLICATIONS

This application is based upon and claims the benefit of priority from prior U.S. Provisional Application No. 61/146,973, filed Jan. 23, 2009, which is incorporated herein by reference.

### BACKGROUND

In order for a bioactive agent to work effectively, it must be delivered to a subject in a way that is both safe and effective. An ideal pharmacokinetic profile of a bioactive agent is one which allows for therapeutic concentrations of the bioactive agent to be reached in a subject, while not exceeding the maximum tolerable dose. For certain pharmacological applications, concentrations of the bioactive agent should remain at a therapeutic level for an extended period of time until the desired therapeutic result is achieved.

Unfortunately, conventional routes for administering bioactive agents often do not provide ideal pharmacokinetic profiles, especially for bioactive agents that display high toxicity and/or narrow therapeutic windows. It is known in the art that one way of affecting a pharmocokinetic profile of a bioactive agent is to encapsulate the bioactive agent in a controlled release system, such as a microparticle or other delivery device. The controlled release system can degrade over time, thereby releasing the bioactive agent according to a release profile that is influenced by the controlled release system.

The release profile or release rate for a bioactive agent may be desired to be different depending on the targeted therapeutic result. Oftentimes, a controlled release system may not provide for a desired release profile, and in some instances can even result in an undesirable release profile. As such, a need exists for controlled release systems and methods for the manufacture thereof that can substantially affect release profiles and release rates for a bioactive agent contained in or on the controlled release system, depending on the composition of the controlled release system itself. These needs and other needs are satisfied by the present invention.

### SUMMARY

Described herein are polymer mixtures and methods for preparing polymer mixtures which comprise a first and second polymer that have at least one different non-repeating unit, e.g., an end group, or a non-repeating unit in the polymer backbone. In one aspect, the at least one different non-repeating unit arises from the use of different initiators used during polymerization. It will be apparent that, in one aspect, the degradation profile or degradation rate of the polymer mixture can be affected by the different repeating unit(s) of the polymers present in the mixture. In a further aspect, the release profile of a controlled release system produced from a disclosed polymer mixture can be likewise affected.

In one aspect, the method for making a polymer mixture comprises a) providing a monomer composition comprising a cyclic ether, a cyclic ester, a cyclic carbonate, or a mixture thereof; and b) contacting the monomer composition with at least two initiators comprising a first initiator and a second initiator that is different from the first initiator under reaction conditions effective to form the polymer mixture. Also disclosed are polymer mixtures and controlled release systems made from the disclosed methods.

Polymer mixtures are also disclosed. In one aspect, the polymer mixture comprises a first polymer having a polymer backbone and one or more non-repeating units, and a second polymer having a polymer backbone and one or more non-repeating units; wherein the first and second polymer comprise a poly(cyclic ether), a poly(cyclic ester), a poly(cyclic carbonate), or a mixture thereof; wherein at least one non-repeating unit of the first polymer is different than at least one non-repeating unit of the second polymer; wherein the polymer backbone of the first polymer is substantially the same as the polymer backbone of the second polymer.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a proton NMR spectra of the polymer from Example 1 (mixed initiators of 1-dodecanol and glycolic acid).

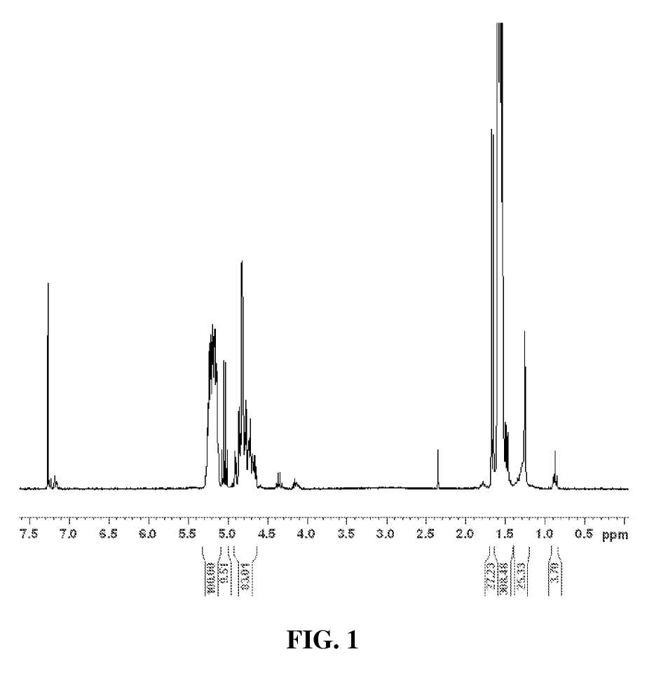

FIG. 2 is a plot of the molecular weight profile of the polymer from Example 1 (mixed initiators of 1-dodecanol and glycolic acid).

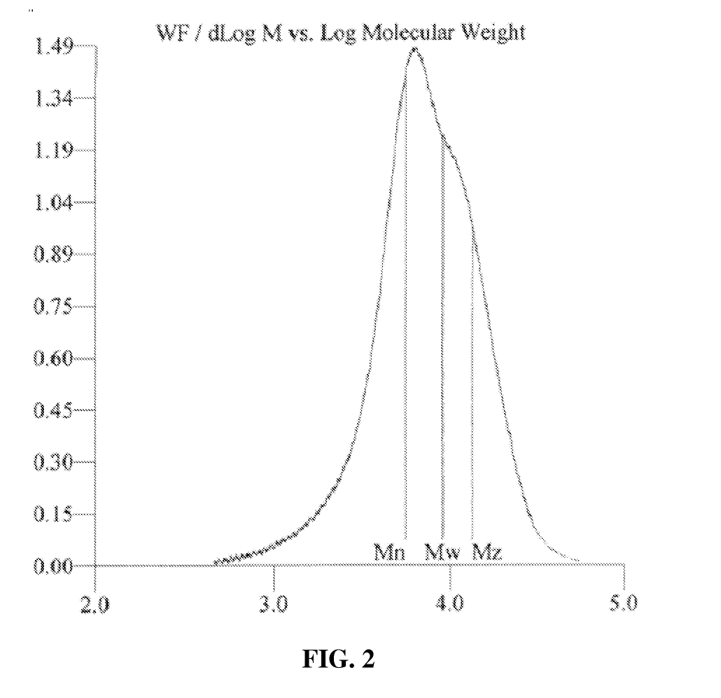

FIG. 3 is a Proton NMR spectra of the polymer from Example 2 (mixed initiators of 1-dodecanol and methyl glycolate).

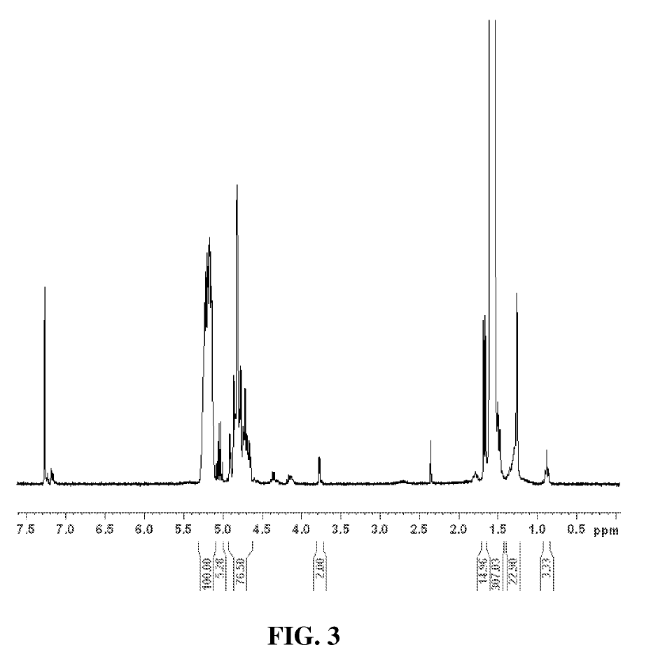

FIG. 4 is a plot of the molecular weight profile of the polymer from Example 2 (mixed initiators of 1-dodecanol and methyl glycolate).

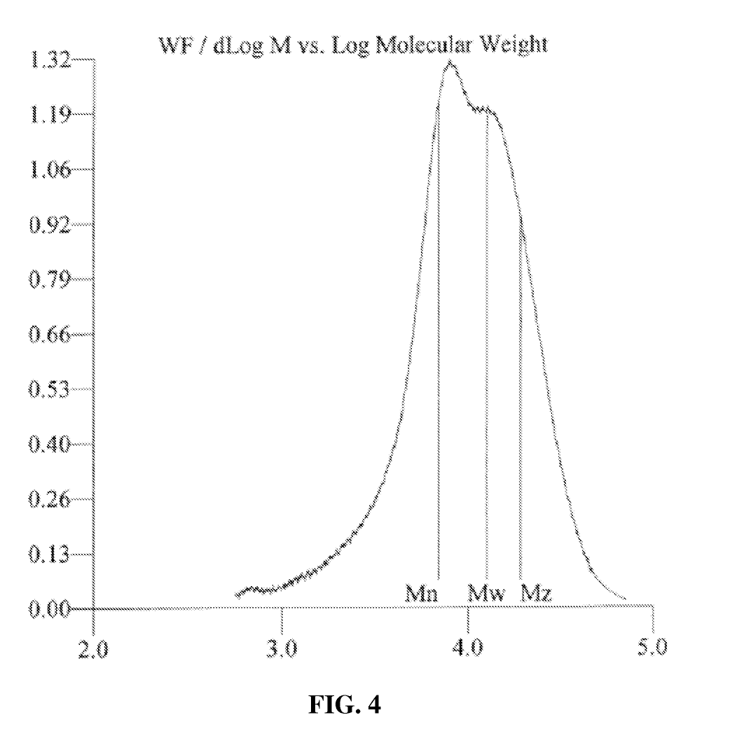

FIG. 5 is a proton NMR spectra of the polymer from Example 3 (mixed initiators of 1-dodecanol and mPEG-2,000).

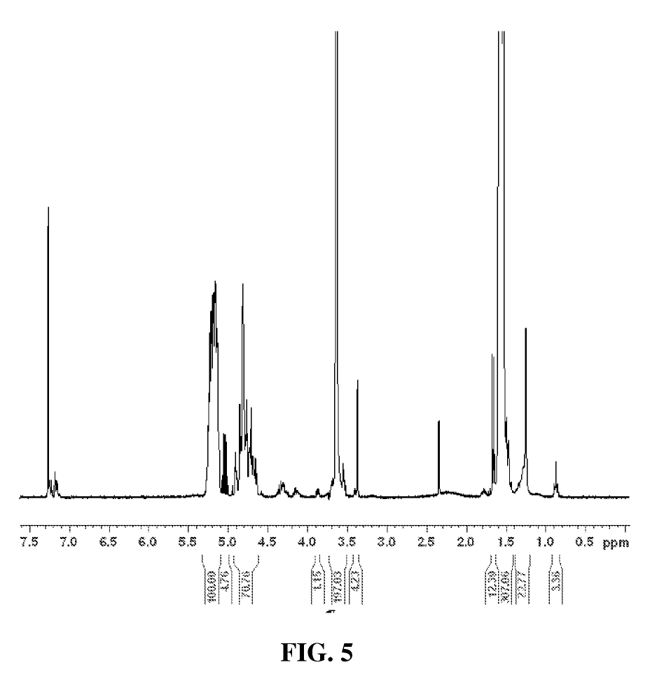

FIG. 6 is a plot of the molecular weight profile of the polymer from Example 3 (mixed initiators of 1-dodecanol and mPEG-2,000).

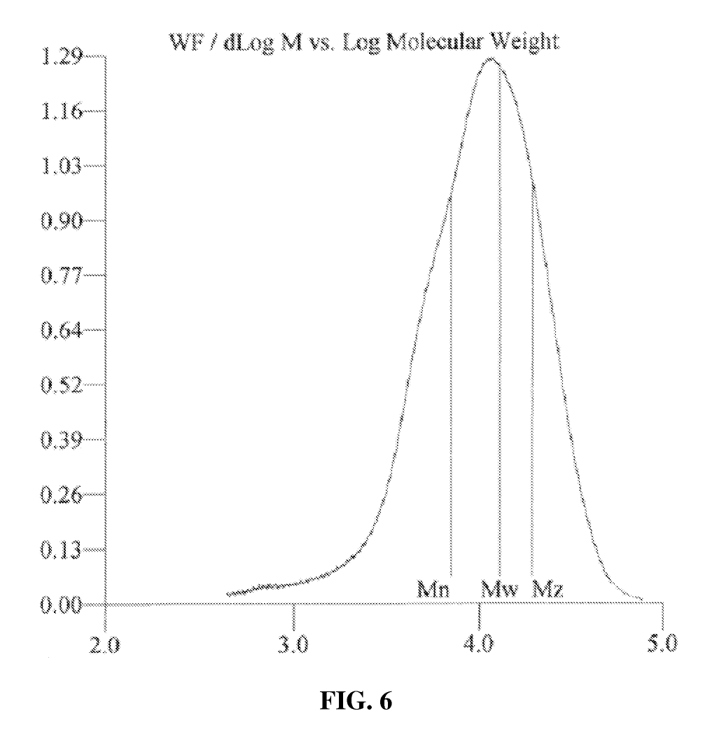

### DETAILED DESCRIPTION

Before the present compounds, compositions, composites, articles, devices and/or methods are disclosed and described, it is to be understood that the aspects described below are not limited to specific compounds, compositions, composites, articles, devices, methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a bioactive agent” includes mixtures of two or more such agents, and the like.

“Optional” or “optionally” means that the subsequently described event or circumstance can or cannot occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

A weight percent of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dode cyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, optionally substituted alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

The term “microparticle” is used herein to refer generally to a variety of structures having sizes from about 10 nm to 2000 microns (2 millimeters) and includes microcapsule, microsphere, nanoparticle, nanocapsule, nanosphere as well as particles, in general that are less than about 2000 microns (2 millimeters). In one aspect, a bioactive agent is encapsulated in the microparticle.

The term “biocompatible” refers a substance that is substantially non-toxic to a subject.

“Biodegradable” is generally referred to herein as a material that will erode to soluble species or that will degrade under physiologic conditions to smaller units or chemical species that are, themselves, non-toxic (biocompatible) to the subject and capable of being metabolized, eliminated, or excreted by the subject.

A “bioactive agent” refers to an agent that has biological activity. The biological agent can be used to treat, diagnose, cure, mitigate, prevent (i.e., prophylactically), ameliorate, modulate, or have an otherwise favorable effect on a disease, disorder, infection, and the like. A “releasable bioactive agent” is one that can be released from a disclosed controlled release system. Bioactive agents also include those substances which affect the structure or function of a subject, or a pro-drug, which becomes bioactive or more bioactive after it has been placed in a predetermined physiological environment. Disclosed are compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a number of different polymers and agents are disclosed and discussed, each and every combination and permutation of the polymer and agent are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

The herein disclosed intrinsic viscosity measurements were performed at 30° C. from polymer solutions prepared at a concentration of 0.5 g/dL in chloroform.

The degradation profile or degradation rate of a controlled release system can be affected by the chemical make-up of the controlled release system. The introduction of a hydrophilic unit into a controlled release system, for example, will typically cause faster water uptake and thus faster degradation of the controlled release system, relative to a controlled release system without the hydrophilic unit. Likewise, a controlled release system having ester bonds will typically degrade faster than a controlled release system having amide bonds, due to the presence of the more labile esters. In a further example, a controlled release system having an acid end group will typically degrade faster than a micparticle having an ester end group, due to greater water uptake induced by the more polar acid end group.

In one aspect, the present disclosure relates to methods for introducing different functional units into a controlled release system to thereby tailor the degradation properties of the controlled release system. In general, the controlled release system can by a wide variety of release systems, including without limitation a microparticle, an implant device, or a drug delivery system, such as a drug-loaded polymer rod. In a further aspect, a functional group is introduced into a controlled release system with the use of a polymerization initiator which is used in forming the polymer from which the controlled release system is made. An initiator typically induces a chemical reaction that would otherwise not occur (i.e., without the initiator) or that would occur slowly without the initiator. In one aspect, the iniator can leave behind a chemical residue as a non-repeating unit in the polymer backbone, or as an end group of the polymer.

In one aspect, as disclosed herein, the degradation properties of a controlled release system can be tailored by using a mixture of polymers, wherein the polymers in the mixture have at least one non-repeating unit that is different. Thus, in one aspect, the mixture of polymers used to form the controlled release system affects the degradation properties of the controlled release system differently than if each polymer were used independently to produce the controlled release system.

Generally, the mixture of polymers can be provided by using an initiator composition comprising at least two different initiators. Each initiator type will provide a corresponding non-repeating unit in the backbone or on the end group of the polymer.

Thus, when an initiator composition comprising at least two different initiators is used, the resulting polymer mixture will comprise polymers which have at least one different non-repeating unit, e.g., an end group, or a non-repeating unit in the polymer backbone.

In one aspect, the polymer mixture can be provided by a) providing a monomer composition; and b) contacting the monomer composition with at least two initiators comprising a first initiator and a second initiator that is different from the first initiator; thereby forming the polymer mixture.

Generally, the monomer composition can comprise any suitable monomer. In one aspect, the monomer composition comprises a cyclic monomer that can be polymerized through ring-opening polymerization. In one aspect, the monomer composition comprises at least two or more monomer types, for example, a monomer and a comonomer, or three monomer types or more. In a further aspect, the monomer composition comprises a cylic ether, a cyclic ester, a cyclic carbonate, or a mixture thereof. Thus, in one aspect, the resulting polymer mixture comprises a poly(cylic ether), a poly(cyclic ester), a poly(cyclic carbonate), or a mixture thereof.

The cyclic ether, when present, can be any cyclic ether which can be polymerized. In one aspect, the cyclic ether can be any cycle comprising an ether therein, which optionally has one or more other heteroatoms therein. In one aspect, the cyclic ether comprises from 2 to 8 carbons, or from 2 to 6 carbons, or from 2 to 4 carbons.

The cyclic ester, when present, can be any cyclic ester which can be polymerized. In one aspect, the cyclic ester can be any cycle comprising an ester therein, which optionally has one or more other heteroatoms therein. In one aspect, the cyclic ester comprises from 2 to 8 carbons, or from 2 to 6 carbons, or from 2 to 4 carbons. In a further aspect, the cyclic ester has a structure represented by the formula:

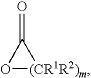

wherein R¹ and R² each comprise m substituents, wherein each substituent independently comprises hydrogen, halogen, hydroxy, thiol, or an optionally substituted organic residue having from 1 to 12 carbons; wherein m is an integer from 1 to 8. A specific non-limiting example of such a cyclic ester is optionally functionalized caprolactone, which has a structure represented by the formula:

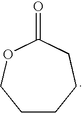

In one aspect, if the monomer composition comprises caprolactone, and if one initiator comprises more than two functionalities that are capable of initiating a polymerization in the monomer composition, then the other initiators do not comprise a mono- or di-functional initiator capable of initiating a polymerization in the monomer composition. The term “functional,” as used in the present context, refers to a group on an initiator that can initiate a polymerization. An example of a polyfunctional initiator for a caprolactone polymerization is a triol, or a higher order alcohol such as, for example, pentaerythritol. Thus, in this example, if caprolactone is present, and if pentaerythritol is present, then the other initiators do not comprise a mono- (e.g., ethanol) or a di-functional initiator (e.g., 1,2-ethanediol) capable of initiating a polymerization in the monomer composition. However, in another aspect, if caprolactone is present, and if one initiator comprises more than two functionalities that are capable of initiating a polymerization in the monomer composition, the other initiators can comprise an initiator having more than two functionalities that are capable of initiating a polymerization in the monomer composition. Thus, using pentaerythritol again as an example, a monomer composition can comprise caprolactone, and the initiators pentaerythritol, and a triol, for example, 2-(hydroxymethyl)propane-1,3-diol.

In another aspect, if the monomer composition comprises a lactone, and if one initiator comprises three or more functionalities that are capable of initiating a polymerization in the monomer composition, then the other initiators do not comprise a mono- or di-functional initiator capable of initiating a polymerization in the monomer composition, as described above.

In a further aspect, the initiators can all independently have one functionality capable of initiating a polymerization in the monomer composition. In one aspect, the initiators can all independently have only one functionality capable of initiating a polymerization in the monomer composition. In another aspect, the initiators all independently have one or two functionalities capable of initiating a polymerization in the monomer composition. It is also understood that the initiators can be the same or different, provided that at least one initiator is different from another. In still another aspect, the monomer composition comprises one monomer type. For example, the monomer composition can comprise only one monomer.

In a further aspect, the cyclic ester, when present, can be a cyclic diester which can be polymerized. In one aspect, the cyclic diester can be any cycle comprising at least two esters therein, which optionally has one or more other heteroatoms therein. In one aspect, the cyclic diester comprises from 2 to 8 carbons, or from 2 to 6 carbons, or from 2 to 4 carbons. In a further aspect, the cyclic diester can be a lactide or glycolide. Any lactide or glycolide residue can be used, including all racemic and stereospecific forms of lactide, including, but not limited to, L-lactide, D-lactide, and D,L-lactide, or a mixture thereof. In a specific aspect, the monomer composition comprises lactide, glycolide, or a combination thereof.

In one aspect, the monomer compositions can comprise one or more monomers. If a copolymer is desired for use, two or or monomers can be polymerized in the same pot, for example, to produce a random copolymer. In another aspect, if a block or blocky copolymer is desired, one monomer can be polymerized using an initiator, while a second monomer can be added at some point after a “living” polymer chain of the first monomer has been formed. Likewise, additional polymers can be grafted onto the polymer, or a monomer can be attached, and the monomer can be polymerized from the polymer backbone, sidechain, or endgroup.

The monomer compositions can be provided through commercial sources, or by synthetic methods for making the monomers which are known in the art.

The monomer compositions can be polymerized by contacting the monomer composition with at least two initiators comprising a first initiator and a second initiator that is different from the first initiator. In one aspect, when the polymers in the polymer mixture are produced from a cyclic monomer, the cyclic monomer can be ring-opened using an initiator with an optionally present catalyst (e.g. a transition metal catalyst such as stannous octanoate) to produce the polymer mixture. In one aspect, the first and second polymer are produced in one-pot to produce a polymer mixture comprising the first and second polymer. In certain aspects, for example, the monomer composition, first initiator, and second initiator are present in one vessel. In other aspects, each polymer can be produced separately and then admixed to provide the polymer mixture.

Any suitable initiator can be used, depending on the method of polymerization. In one aspect, the first and/or second initiator is a nucleophile. In general, any nucleophile can be used. In one aspect, a portion of the nucleophile remains on the polymer as at least one non-repeating unit of the polymer, e.g., an end group, or a non-repeating unit in the polymer backbone. Thus, in one aspect, the selection of the nucleophile can be made based on the desired composition of the non-repeating units of the first and second polymer. In one aspect, the first or second initiator comprises one or more of water, a hydroxyl acid, an alcohol, an amine, or a thiol. When the first or second polymer is made from a cyclic ether, cyclic ester, a cyclic carbonate, or a mixture thereof, the first and/or second initiator can be one or more of water, R⁵OH, R⁵NH₂, R⁵N═H, R⁵SH; wherein R⁵ is an optionally substituted organic residue comprising from 1 to 18 carbons.

When the first and/or second initiator is R⁵OH, R⁵NH₂, R⁵N═H, or R⁵SH, R⁵ can include without limitation optionally substituted alkane or heteroalkane, optionally substituted alkene or heteralkene, optionally substituted alkyne or heteralkyne, optionally substituted cycloalkane or heterocycloalkane, optionally substituted cycloalkene or heterocycloalkene, optionally substituted cycloalkyne or heterocycloalkyne, optionally substituted aryl or heteraryl.

In one aspect, the first and/or second initiator can be a di- or multi- functional (i.e. multi-nucleophilic) initiator, that is, an initiator having more than one nucleophilic atoms that can initiate polymerization. Thus, for example, the first and/or second initiator can comprise Nu-R⁵OH, Nu-R⁵NH₂, Nu-R⁵N═H, Nu-R⁵SH, wherein Nu can be any nucleophile, including without limitation, alchohols, amines, imides, thiols, and the like. As used herein, alcohols, amines, imides, and thiols include both monofunctional and multifunctional alcohols, amines, imides, thiols, and combinations thereof, including without limitation diols, diamines, diimides, dithiols, triols, triamines, triimides, higher order alcohols, amines, imides, and thiols, and combinations thereof. In one aspect, a multifunctional initiator, such as for example, pentaerythritol can be used.

In a further aspect, the first and/or second initiator comprises one or more of a hydroxyl acid, water, ethanol, 1-propanol, 1-butanol, 1-pentanol, 1-hexanol, docecanol, phenol, 1,6-hexane diol, 1-4 butane diol, lauryl alcohol, glycerol, penterythitol, glucose, dextrose, sucrose, glycolic acid, lactic acid, tyrosine, mono- or di-alcohol functionalized poly(ethylene glycol) (PEG), 1-aminohexane, 1,6-diaminohexane, or an amino acid, for example, glycine, or arginine.

In a specific aspect, the first or second initiator comprises one or more of water, 1-dodecanol, hexane diol, lactic acid, glycolic acid, or a combination thereof. In another specific aspect, the first or second initiator comprises one or more of 1-aminohexane, 1,6-diaminohexane, glycine, or arginine. In a further specific aspect, the first or second initiator comprises water and an alcohol. In another specific aspect, the first or second initiator comprises a hydroxyl acid and an alcohol. In another specific aspect, the first or second initiator comprises hydroxyl terminated poly(ethylene glycol) (PEG) and an alcohol. In another specific aspect, the first or second initiator comprises hydroxyl terminated poly(ethylene glycol) (PEG) and water.

Any two or more of the above described initiators can be used to initiate polymerization of the monomer composition, provided that at least two of the initiators present are different. Also disclosed are polymer mixtures provided by the disclosed methods. Also disclosed are controlled release systems made from the polymer mixtures provided by the disclosed methods. In one aspect, the polymers are for use in a medical application.

In general, the polymer mixtures can be made by those methods disclosed above or by other methods. As such, the disclosed polymer mixtures are not limited by a production method. The polymer mixtures, as discussed above, generally comprise a first polymer having a polymer backbone and one or more non-repeating units, and a second polymer having a polymer backbone and one or more non-repeating units; wherein at least one non-repeating unit of the first polymer is different than at least one non-repeating unit of the second polymer.

As discussed above, the non-repeating units can alter the degradation profile or degradation rate of the polymer. The backbone of the polymers in the mixture can be the same or different. To that end, in one aspect, the first and second polymer share a monomeric precursor. In a further aspect, the polymers are produced from the same monomer, with the use of different initiators for at least two of the monomers. Thus, in one aspect, the polymer backbone of the first polymer is substantially the same as the polymer backbone of the second polymer. In a further aspect, the first and second polymer have the same polymer backbone.

The term “polymer backbone” is meant to refer to the portion or portions of the polymer that comprise repeating residues. A polymer backbone can comprise a non-repeating unit, which interrupts repeating residues, as will be apparent. For a specific non-limitating example, the polymer backbone and non-repeating units of the following poly(lactide) are labeled.

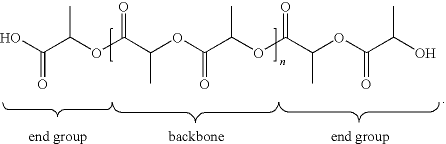

As can be seen from this example, a non-repeating unit can be an end group. Thus, in one aspect, a non-repeating unit is a unit that terminates a repeating portion of the polymer.

One or more non-repeating unit(s) of the first polymer can be different than one or more non-repeating unit(s) of the second polymer. In one aspect, one non-repeating unit of the first polymer is different than one non-repeating unit of the second polymer. As discussed above, the non-repeating units can be an end group, or a non-repeating unit in the polymer backbone itself. Thus, in one aspect, at least one end group of the first polymer is different than at least one endgroup of the second polymer. In a further aspect, one end group of the first polymer is different than one endgroup of the second polymer. Likewise, in one aspect, at least one non-repeating unit in the backbone of the first polymer is different than at least one non-repeating unit in the backbone of the second polymer. In a further aspect, one non-repeating unit in the backbone of the first polymer is different than one non-repeating unit in the backbone of the second polymer.

The polymers can be homopolymers or copolymers, including without limitation block or blocky co- or ter-polymers, random co- or ter-polymers, star polymers, telechelic polymers, or dendrimers. Any desired molecular weight polymer can be used, depending on the desired properties of the controlled release system formed from the polymer mixture. In certain aspects, if a high strength controlled release system is desired, then high molecular weight polymers can be used, for example, to meet strength requirements. In other aspects, low or medium molecular weight polymers can be used when, for example, when resorption time of the polymer, rather than material strength is desired. In one aspect, one of the first and/or second polymers can be a higher molecular weight polymer, and the other polymer can be a lower molecular weight polymer. Additionally, it is understood that other polymers and/or additives can be present in the polymer mixture comprising the first and second polymer.

The first and second polymer can be any polymer having at least one difference between a non-repeating unit therein. In one aspect, the first and/or second polymer is a polymer produced from a monomer disclosed above. Thus, in one aspect, the first and/or second polymer comprises a poly(cyclic ether), a poly(cyclic ester), a poly(cyclic carbonate), or a mixture thereof.

In one aspect, the poly(cyclic ester) has a structure represented by the formula:

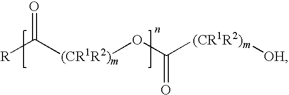

wherein R¹, R², and m are defined above, wherein R is an end group; and wherein n is the number of repeating units. Thus, the non-repeating units of the above poly(cyclic ester) are R—, and —CO(CR¹R²)ₘ—OH. A specific non-limiting example of such a poly(cyclic ester) is optionally functionalized caprolactone, which has a structure represented by the formula:

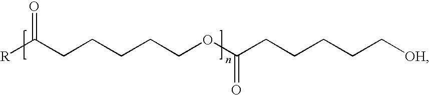

wherein R is an end group, and wherein n is the number of repeating units.

In one aspect, if the first polymer is a poly(caprolactone) homopolymer having three or more arms, then the second polymer is not a poly(caprolactone) homopolymer having less than three arms. Thus, for example, if the first polymer has a structure represented by the formula:

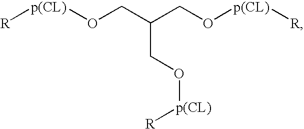

wherein p(CL) is poly(caprolactone) and wherein R is an end group, then the second polymer is a not a poly(caprolactone) homopolymer having less than three arms, e.g., a polymer having a structure represented by the formula:

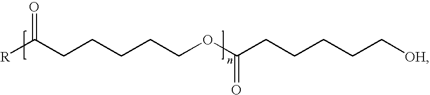

wherein R is an end group, and wherein n is the number of repeating units.

In a further aspect, if the first polymer is a poly(lactone) homopolymer having three or more arms, then the second polymer is not a poly(lactone) homopolymer having less than three arms.

In one aspect, the first and second polymers are linear polymers. In a further aspect, the first and second polymers have one or two arms. In a still further aspect, the first and second polymers are copolymers. The first and second polymer can be different, for example, one can be linear, while the other has two arms, and the like.

A specific, non-limiting example or a polymer mixture having at least one non-repeating unit that is different among the polymers is a polymer mixture comprising the following two polymers:

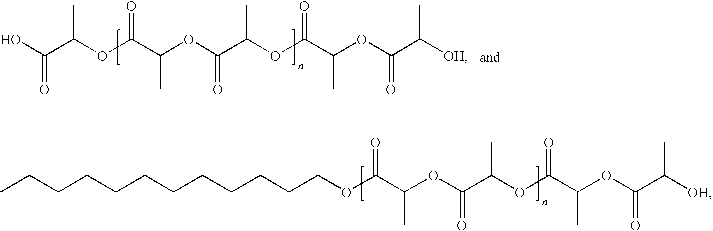

in any desired ratio (e.g., 50/50); wherein n is the number of repeating units. In the above specific example, both polymers have the same poly(lactide) backbone. Likewise, both polymers have an alcohol-based end group. As shown, however, the other end groups of the polymer differ. Specifically, one polymer has an carboxylic acid end, while the other polymer has an ester end group. It will be apparent that the above mixture can be provided, for example, by polymerizing a monomer composition comprising a lactide monomer using 1) a lactic acid initiator and 2) a 1-dodecanol initiator. The amount of polymer and molecular weight of the polymer produced from each initiator will generally depend on the initiator:initiator ratio and the monomer:initiator ratio used.

It will be apparent that when a di- or multi- functional (nucleophilic) initiator is used, the resulting polymer mixture can have at least one non-repeating unit in the polymer backbone (i.e., a residue that interrupts repeating units) that differs between two or more polymers. Thus, in one aspect, the end groups of the polymers are the same, but the polymers have at least one different non-repeating unit in the polymer backbone. When a multi-nucleophillic initiator is used, the resulting polymer can be a branched polymer, including without limitation a star polymer or a dendrimer.

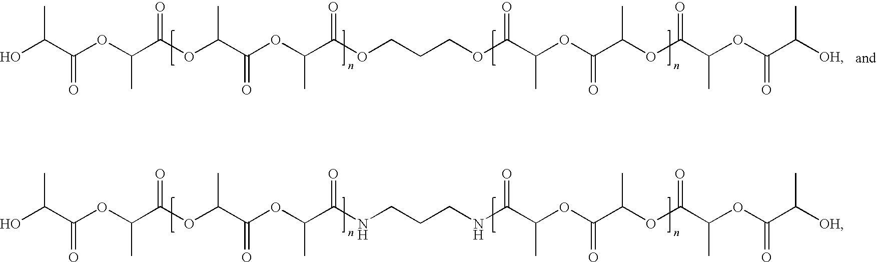

wherein n is the number of repeating units.

The non-repeating unit that is different among the first and second polymer can have any structure, depending in various aspects on the structure of the initiator used. In one aspect, the different non-repeating unit is one which is derived from an above disclosed initiator. Thus, in various aspects, the different non-repeating unit can comprise an alcohol, ester, thiol, carboxylic acid, amine, amide, imide, and the like.

Other than through the use of an initiator, non-repeating units of a polymer can be altered to provide a disclosed polymer mixture. In one aspect, a quencher can be used to terminate a polymerization, thereby leaving behind a residue of the quencher on the polymer, e.g., as an end group. In a similar aspect, when a monomer, initiator, or quencher has a functional group that can produce a non-repeating unit of a polymer, it can be possible to functionalize the non-repeating unit to provide another, different non-repeating unit. In one aspect, for example, each polymer is produced separately, and a non-repeating unit of one or more of the polymers is modified post-polymerization, and then the polymers are combined to provide a disclosed mixture. It should be understood that any combination, in any disclosed polymer mixture, of the above scenarious for non-repeating unit formation can be used to provide the polymer mixture.

In one aspect, the first polymer has an end group comprising an ester, and the second polymer has an end group comprising a carboxylic acid. In another aspect, the first polymer has an end group comprising poly(ethylene glycol), and the second polymer has an end group comprising an ester. In a further aspect, the first polymer has an end group comprising poly(ethylene glycol), and the second polymer has an end group comprising a carboxylic acid. In a still further aspect, the first or second polymer is poly(lactide), poly(glycolide), or poly(lactide-co-glycolide).

The polymers disclosed herein can also be copolymers, including without limitation block or blocky copolymers, random copolymers, block, blocky, or random terpolymers. In one aspect, the first and/or second polymer can comprise one or more blocks of hydrophilic or water soluble polymers, including, but not limited to, polyethylene glycol, (PEG), or polyvinyl pyrrolidone (PVP), in combination with one or more blocks another biocompabible or biodegradable polymer that comprises lactide, glycolide, caprolactone, or a mixture thereof.

When the biodegradable polymer is poly(lactide-co-glycolide), poly(lactide), or poly(glycolide), the amount of lactide and glycolide in the polymer can vary. In a further aspect, the biodegradable polymer contains 0 to 100 mole %, 40 to 100 mole %, 50 to 100 mole %, 60 to 100 mole %, 70 to 100 mole %, or 80 to 100 mole % lactide and from 0 to 100 mole %, 0 to 60 mole %, 10 to 40 mole %, 20 to 40 mole %, or 30 to 40 mole % glycolide, wherein the amount of lactide and glycolide is 100 mole %. In a further aspect, the biodegradable polymer can be poly(lactide), 95:5 poly(lactide-co-glycolide) 85:15 poly(lactide-co-glycolide), 75:25 poly(lactide-co-glycolide), 65:35 poly(lactide-co-glycolide), or 50:50 poly(lactide-co-glycolide), where the ratios are mole ratios.

In a further aspect, the polymer can be a poly(caprolactone) or a poly(lactide-co-caprolactone). In one aspect, the polymer can be a poly(lactide-caprolactone), which, in various aspects, can be 95:5 poly(lactide-co-caprolactone), 85:15 poly(lactide-co-caprolactone), 75:25 poly(lactide-co- caprolactone), 65:35 poly(lactide-co- caprolactone), or 50:50 poly(lactide-co- caprolactone), where the ratios are mole ratios.

In a specific aspect, the polymer mixture of the invention can comprise two or more different polymers prepared by the polymerization of lactide, glycolide, caprolactone, or any combination thereof using the following mixture of polymerization initiators: (1-dodecanol and glycolic acid), (1-dodecanol and methyl glycolate), (1-dodecanol and mPEG-2,000), or (1-dodecanol and ethyl glycolate).

In a a further specific aspect, the polymer of the invention can be a polymer prepared by the polymerization both lactide and glycolide using the following mixture of polymerization initiators: (1-dodecanol and glycolic acid), (1-dodecanol and methyl glycolate), (1-dodecanol and mPEG-2,000), or (1-dodecanol and ethyl glycolate). The polymerization initiators form to what is referred to herein as non-repeating units.

It is understood that any combination of the aforementioned polymers can be used, including, but not limited to, copolymers thereof, mixtures thereof, or blends thereof. Likewise, it is understood that when a residue of a polymer is disclosed, any suitable polymer, copolymer, mixture, or blend, that comprises the disclosed residue, is also considered disclosed. To that end, when multiple residues are individually disclosed (i.e., not in combination with another), it is understood that any combination of the individual residues can be used.

Controlled release systems made from the polymer mixtures are also disclosed. The controlled release system, as discussed above, can be any controlled release system, such as a microparticle, implant device, or drug delivery system, such as a drug-loaded polymer rod.

In one aspect, the controlled release system is a microparticle. In general, the microparticles can be any suitable microparticle made from a disclosed polymer mixture. In one aspect, the microparticle comprises a suitable biocompatible and biodegradable or non-biodegradable polymer. In one aspect, a bioactive agent is encapsulated within the microparticle. In another aspect, the bioactive agent is associated with the microparticle.

In one aspect, the method of forming the polymer mixture further comprises forming a microparticle from the polymer mixture. In a further aspect, the method of forming the polymer mixture further comprises forming an admixture comprising the polymer mixture and a bioactive agent; and forming a microparticle from the admixture. In a still further aspect, a method for making a microparticle comprises a) providing a polymer mixture comprising a first polymer having a backbone and at least one non-repeating unit, and a second polymer having a backbone and at least one non-repeating unit; wherein at least one non-repeating unit of the first polymer is different from at least one non-repeating unit of the second polymer; and b) forming a microparticle from the polymer mixture. Optionally, a bioactive agent or other substance (e.g., fertilizer, photoactive agent, etc.) can be admixed with the polymer mixture. Subsequently, a microparticle can be formed from the admixture. Such a method, in various aspects, can provide a microparticle having a releasable agent therein. Thus, in one aspect, the microparticle encapsulates a releasable agent, such as for example, a bioactive agent or other releasable substance.

When a biodegradable polymer is used, the microparticle can be formulated so as to degrade within a desired time interval, once present in a subject. In some aspects, the time interval can be from about less than one day to about 1 month. Longer time intervals can extend to 6 months, including for example, polymer matrices that degrade from about ≧0 to about 6 months, or from about 1 to about 6 months. In other aspects, the polymer can degrade in longer time intervals, up to 2 years or longer, including, for example, from about ≧0 to about 2 years, or from about 1 month to about 2 years. It will be appreciated that the selection of the initiator and/or end group of the first and/or second polymer can be affect the degradation profile of the microparticle.

In one aspect, the controlled release system comprises a bioactive agent. The bioactive agent can be released from the controlled release system under a desired release profile. In one aspect, the desired release profile can influence the selection of the polymer. A biocompatible polymer, for example, can be selected so as to release or allow the release of a bioactive agent therefrom at a desired lapsed time after the controlled release system has been administered to a subject. For example, the polymer can be selected to release or allow the release of the bioactive agent prior to the bioactive agent beginning to diminish its activity, as the bioactive agent begins to diminish in activity, when the bioactive agent is partially diminished in activity, for example at least 25%, at least 50% or at least 75% diminished, when the bioactive agent is substantially diminished in activity, or when the bioactive agent is completely gone or no longer has activity.

In general, the release profile can be any desired release profile, depending on the therapy for which the bioactive agent will be used. In a further aspect, the release profile is one or more of controlled-release, extended-release, modified-release, sustained-release, pulsatile-release, delayed-release, or programmed-release, including cyclical-release.

In one aspect, the controlled release system can be comprised of any of those polymers mentioned above optionally in combination with any other polymer used in the controlled release system art. In general, the above mentioned first and second polymers can be cross-linked to a certain level, which thereby can form a controlled release system of the polymer, as is known in the art.

When the controlled release system is a microparticle, the microparticles can have an average or mean particle size of from about 20 microns to about 125 microns. In one embodiment the range of mean particle size is from about 40 microns to about 90 microns. In another embodiment the range of mean particle sizes is from about 50 microns to about 80 microns. Particle size distributions are measured by laser diffraction techniques known to those of skill in the art.

In a further aspect, the bioactive agent can be encapsulated, microencapsulated, or otherwise contained within a microparticle. The microparticle can modulate the release of the bioactive agent. The microparticle can comprise any desired amount of the bioactive agent. For example, the microparticle can comprise 1%, 5%, 10%, 20%, 30%, 40%, 50%, 60%, 70%, 80%, 90%, 95% by weight bioactive agent, relative to the weight of the microparticle, including any range between the disclosed percentages.

The microparticles can be made using methods known in the art, including, for example, those methods disclosed in U.S. Patent Publication No. 2007/0190154 to Zeigerson, published Aug. 16, 2007, and U.S. Pat. No. 5,407,609 to Tice et al., both of which are incorporated herein in their entirety by this reference for teachings of microparticle preparation methods. As will be apparent, depending upon processing conditions, the polymer used as a starting material in the admixing step may or may not be the same polymer present in the final controlled release system. For example, the polymer during processing may undergo polymerization or depolymerization reactions, which ultimately can produce a different polymer that was used prior to processing. Thus, the term “polymer” as used herein covers the polymers used as starting materials as well as the final polymer present in the device produced by the methods described herein. Methods for making controlled release systems can be used in combination with the drying methods and dyring parameters described above.

Various forms of the bioactive agent can be used, which are capable of being released from the controlled release system into adjacent tissues or fluids of a subject. To that end, a liquid or solid bioactive agent can be incorporated into the controlled release systems described herein. The bioactive agents are at least very slightly water soluble, and preferably moderately water soluble. The bioactive agents can include salts of the active ingredient. As such, the bioactive agents can be acidic, basic, or amphoteric salts. They can be nonionic molecules, polar molecules, or molecular complexes capable of hydrogen bonding. The bioactive agent can be included in the compositions in the form of, for example, an uncharged molecule, a molecular complex, a salt, an ether, an ester, an amide, polymer drug conjugate, or other form to provide the effective biological or physiological activity.

Examples of bioactive agents that incorporated into systems herein include, but are not limited to, peptides, proteins such as hormones, enzymes, antibodies and the like, nucleic acids such as aptamers, iRNA, DNA , RNA, antisense nucleic acid or the like, antisense nucleic acid analogs or the like, low-molecular weight compounds, or high-molecular-weight compounds. Bioactive agents contemplated for use in the disclosed micropartices include anabolic agents, antacids, anti-asthmatic agents, anti-cholesterolemic and anti-lipid agents, anti-coagulants, anti-convulsants, anti-diarrheals, anti-emetics, anti-infective agents including antibacterial and antimicrobial agents, anti-inflammatory agents, anti-manic agents, antimetabolite agents, anti-nauseants, anti-neoplastic agents, anti-obesity agents, anti-pyretic and analgesic agents, anti-spasmodic agents, anti-thrombotic agents, anti-tussive agents, anti-uricemic agents, anti-anginal agents, antihistamines, appetite suppressants, biologicals, cerebral dilators, coronary dilators, bronchiodilators, cytotoxic agents, decongestants, diuretics, diagnostic agents, erythropoietic agents, expectorants, gastrointestinal sedatives, hyperglycemic agents, hypnotics, hypoglycemic agents, immunomodulating agents, ion exchange resins, laxatives, mineral supplements, mucolytic agents, neuromuscular drugs, peripheral vasodilators, psychotropics, sedatives, stimulants, thyroid and anti-thyroid agents, tissue growth agents, uterine relaxants, vitamins, or antigenic materials.

Other bioactive agents include androgen inhibitors, polysaccharides, growth factors (e.g., a vascular endothelial growth factor—VEGF), hormones, anti-angiogenesis factors, dextromethorphan, dextromethorphan hydrobromide, noscapine, carbetapentane citrate, chlophedianol hydrochloride, chlorpheniramine maleate, phenindamine tartrate, pyrilamine maleate, doxylamine succinate, phenyltoloxamine citrate, phenylephrine hydrochloride, phenylpropanolamine hydrochloride, pseudoephedrine hydrochloride, ephedrine, codeine phosphate, codeine sulfate morphine, mineral supplements, cholestryramine, N-acetylprocainamide, acetaminophen, aspirin, ibuprofen, phenyl propanolamine hydrochloride, caffeine, guaifenesin, aluminum hydroxide, magnesium hydroxide, peptides, polypeptides, proteins, amino acids, hormones, interferons, cytokines, and vaccines.

Representative drugs that can be used as bioactive agents in the controlled release systems include, but are not limited to, peptide drugs, protein drugs, desensitizing materials, antigens, anti-infective agents such as antibiotics, antimicrobial agents, antiviral, antibacterial, antiparasitic, antifungal substances and combination thereof, antiallergenics, androgenic steroids, decongestants, hypnotics, steroidal anti-inflammatory agents, anti-cholinergics, sympathomimetics, sedatives, miotics, psychic energizers, tranquilizers, vaccines, estrogens, progestational agents, humoral agents, prostaglandins, analgesics, antispasmodics, antimalarials, antihistamines, cardioactive agents, nonsteroidal anti-inflammatory agents, antiparkinsonian agents, antihypertensive agents, β-adrenergic blocking agents, nutritional agents, and the benzophenanthridine alkaloids. The agent can further be a substance capable of acting as a stimulant, sedative, hypnotic, analgesic, anticonvulsant, and the like.

The controlled release system can comprise a large number of bioactive agents either singly or in combination. Other bioactive agents include but are not limited to analgesics such as acetaminophen, acetylsalicylic acid, and the like; anesthetics such as lidocaine, xylocaine, and the like; anorexics such as dexadrine, phendimetrazine tartrate, and the like; antiarthritics such as methylprednisolone, ibuprofen, and the like; antiasthmatics such as terbutaline sulfate, theophylline, ephedrine, and the like; antibiotics such as sulfisoxazole, penicillin G, ampicillin, cephalosporins, amikacin, gentamicin, tetracyclines, chloramphenicol, erythromycin, clindamycin, isoniazid, rifampin, and the like; antifungals such as amphotericin B, nystatin, ketoconazole, and the like; antivirals such as acyclovir, amantadine, and the like; anticancer agents such as cyclophosphamide, methotrexate, etretinate, and the like; anticoagulants such as heparin, warfarin, and the like; anticonvulsants such as phenytoin sodium, diazepam, and the like; antidepressants such as isocarboxazid, amoxapine, and the like;antihistamines such as diphenhydramine HCl, chlorpheniramine maleate, and the like; hormones such as insulin, progestins, estrogens, corticoids, glucocorticoids, androgens, and the like; tranquilizers such as thorazine, diazepam, chlorpromazine HCl, reserpine, chlordiazepoxide HCl, and the like; antispasmodics such as belladonna alkaloids, dicyclomine hydrochloride, and the like; vitamins and minerals such as essential amino acids, calcium, iron, potassium, zinc, vitamin B₁₂, and the like; cardiovascular agents such as prazosin HCl, nitroglycerin, propranolol HCl, hydralazine HCl, pancrelipase, succinic acid dehydrogenase, and the like; peptides and proteins such as LHRH, somatostatin, calcitonin, growth hormone, glucagon-like peptides, growth releasing factor, angiotensin, FSH, EGF, bone morphogenic protein (BMP), erythopoeitin (EPO), interferon, interleukin, collagen, fibrinogen, insulin, Factor VIII, Factor IX, Enbrel®, Rituxam®, Herceptin®, alpha-glucosidase, Cerazyme/Ceredose®, vasopressin, ACTH, human serum albumin, gamma globulin, structural proteins, blood product proteins, complex proteins, enzymes, antibodies, monoclonal antibodies, and the like; prostaglandins; nucleic acids; carbohydrates; fats; narcotics such as morphine, codeine, and the like, psychotherapeutics; anti-malarials, L-dopa, diuretics such as furosemide, spironolactone, and the like; antiulcer drugs such as rantidine HCl, cimetidine HCl, and the like.

The bioactive agent can also be an immunomodulator, including, for example, cytokines, interleukins, interferon, colony stimulating factor, tumor necrosis factor, and the like; allergens such as cat dander, birch pollen, house dust mite, grass pollen, and the like; antigens of bacterial organisms such as Streptococcus pneumoniae, Haemophilus influenzae, Staphylococcus aureus, Streptococcus pyrogenes, Corynebacterium diphteriae, Listeria monocytogenes, Bacillus anthracis, Clostridium tetani, Clostridium botulinum, Clostridium perfringens. Neisseria meningitides, Neisseria gonorrhoeae, Streptococcus mutans. Pseudomonas aeruginosa, Salmonella typhi, Haemophilus parainfluenzae, Bordetella pertussis, Francisella tularensis, Yersinia pestis, Vibrio cholerae, Legionella pneumophila, Mycobacterium tuberculosis, Mycobacterium leprae, Treponema pallidum, Leptspirosis interrogans, Borrelia burgddorferi, Campylobacter jejuni, and the like; antigens of such viruses as smallpox, influenza A and B, respiratory synctial, parainfluenza, measles, HIV, SARS, varicella-zoster, herpes simplex 1 and 2, cytomeglavirus, Epstein-Barr, rotavirus, rhinovirus, adenovirus, papillomavirus, poliovirus, mumps, rabies, rubella, coxsackieviruses, equine encephalitis, Japanese encephalitis, yellow fever, Rift Valley fever, lymphocytic choriomeningitis, hepatitis B, and the like; antigens of such fungal, protozoan, and parasitic organisms such as Cryptococcuc neoformans, Histoplasma capsulatum, Candida albicans, Candida tropicalis, Nocardia asteroids, Rickettsia ricketsii, Rickettsia typhi, Mycoplasma pneumoniae, Chlamyda psittaci, Chlamydia trachomatis, Plasmodium falciparum, Trypanasoma brucei, Entamoeba histolytica, Toxoplasma gondii, Trichomonas vaginalis, Schistosoma mansoni, and the like. These antigens may be in the form of whole killed organisms, peptides, proteins, glycoproteins, carbohydrates, or combinations thereof.

In a further specific aspect, the bioactive agent comprises an antibiotic. The antibiotic can be, for example, one or more of Amikacin, Gentamicin, Kanamycin, Neomycin, Netilmicin, Streptomycin, Tobramycin, Paromomycin, Ansamycins, Geldanamycin, Herbimycin, Carbacephem, Loracarbef, Carbapenems, Ertapenem, Doripenem, Imipenem/Cilastatin, Meropenem, Cephalosporins (First generation), Cefadroxil, Cefazolin, Cefalotin or Cefalothin, Cefalexin, Cephalosporins (Second generation), Cefaclor, Cefamandole, Cefoxitin, Cefprozil, Cefuroxime, Cephalosporins (Third generation), Cefixime, Cefdinir, Cefditoren, Cefoperazone, Cefotaxime, Cefpodoxime, Ceftazidime, Ceftibuten, Ceftizoxime, Ceftriaxone, Cephalosporins (Fourth generation), Cefepime, Cephalosporins (Fifth generation), Ceftobiprole, Glycopeptides, Teicoplanin, Vancomycin, Macrolides, Azithromycin, Clarithromycin, Dirithromycin, Erythromycin, Roxithromycin, Troleandomycin, Telithromycin, Spectinomycin, Monobactams, Aztreonam, Penicillins, Amoxicillin, Ampicillin, Azlocillin, Carbenicillin, Cloxacillin, Dicloxacillin, Flucloxacillin, Mezlocillin, Meticillin, Nafcillin, Oxacillin, Penicillin, Piperacillin, Ticarcillin, Polypeptides, Bacitracin, Colistin, Polymyxin B, Quinolones, Ciprofloxacin, Enoxacin, Gatifloxacin, Levofloxacin, Lomefloxacin, Moxifloxacin, Norfloxacin, Ofloxacin, Trovafloxacin, Sulfonamides, Mafenide, Prontosil (archaic), Sulfacetamide, Sulfamethizole, Sulfanilimide (archaic), Sulfasalazine, Sulfisoxazole, Trimethoprim, Trimethoprim-Sulfamethoxazole (Co-trimoxazole) (TMP-SMX), Tetracyclines, including Demeclocycline, Doxycycline, Minocycline, Oxytetracycline, Tetracycline, and others; Arsphenamine, Chloramphenicol, Clindamycin, Lincomycin, Ethambutol, Fosfomycin, Fusidic acid, Furazolidone, Isoniazid, Linezolid, Metronidazole, Mupirocin, Nitrofurantoin, Platensimycin, Pyrazinamide, Quinupristin/Dalfopristin, Rifampicin (Rifampin in U.S.), Tinidazole, or a combination thereof. In one aspect, the bioactive agent can be a combination of Rifampicin (Rifampin in U.S.) and Minocycline.

In certain aspects, the bioactive agent can be present as a component in a pharmaceutical composition. Pharmaceutical compositions can be conveniently prepared in a desired dosage form, including, for example, a unit dosage form or controlled release dosage form, and prepared by any of the methods well known in the art of pharmacy. In general, pharmaceutical compositions are prepared by uniformly and intimately bringing the bioactive agent into association with a liquid carrier or a finely divided solid carrier, or both. The pharmaceutical carrier employed can be, for example, a solid, liquid, or gas. Examples of solid carriers include lactose, terra alba, sucrose, talc, gelatin, agar, pectin, acacia, magnesium stearate, and stearic acid. Examples of liquid carriers are sugar syrup, peanut oil, olive oil, and water. Examples of gaseous carriers include carbon dioxide and nitrogen. Other pharmaceutically acceptable carriers or components that can be mixed with the bioactive agent can include, for example, a fatty acid, a sugar, a salt, a water-soluble polymer such as polyethylene glycol, a protein, polysacharride, or carboxmethyl cellulose, a surfactant, a plasticizer, a high- or low-molecular-weight porosigen such as polymer or a salt or sugar, or a hydrophobic low-molecular-weight compound such as cholesterol or a wax.

The controlled release system can be administered to any desired subject. The subject can be a vertebrate, such as a mammal, a fish, a bird, a reptile, or an amphibian. The subject of the herein disclosed methods can be, for example, a human, non-human primate, horse, pig, rabbit, dog, sheep, goat, cow, cat, guinea pig or rodent. The term does not denote a particular age or sex. Thus, adult and newborn subjects, as well as fetuses, whether male or female, are intended to be covered.

Also disclosed are a variety of medical devices comprising the polymer mixtures or the controlled release system or microparticle made therefrom. In one aspect, the medical device is an implant device. The implant device can comprise any shape, such as a rod, a fiber, a cylinder, a bead, a ribbon, a disc, a wafer, a free-formed shaped solid, or a variety of other shaped solids. The implant devices can include, for example, implants for bioactive agent delivery, including drug delivery pumps; orthopedic implants, including spinal implants, implants for osseointegration or bone repair; medical stents, including stents with inherent drug delivery capability; prosthetic implants, including breast implants, muscle implants, and the like; dental implants; ear implants, including cochlear implants and hearing devices; cardiac implants including pacemakers, catheters, etc.; space filling implants; bioelectric implants; neural implants; internal organ implants, including dialysis grafts; defribrillators; monitoring devices; recording devices; stimulators, including deep brain stimulators, nerve stimulators, bladder stimulators, and diaphragm stimulators; implantable identification devices and information chips; artificial organs; drug administering devices; implantable sensors/biosensors; screws; tubes; rods; plates; or artificial joints. In a specific aspect, the medical device is a controlled release device comprising the polymer mixtures or the controlled release systems together with a bioactive agent, such as for example a drug or vaccine, which can be released from the bioactive agent delivery device. In one aspect, the controlled release system is a drug loaded polymer, such as a rod-shaped or other shaped polymer.

### Examples

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in degrees Centigrade (° C.) or is at ambient temperature, and pressure is at or near atmospheric. There are numerous variations and combinations of reaction conditions, e.g., component concentrations, component mixtures, desired solvents, solvent mixtures, temperatures, pressures and other reaction ranges and conditions that can be used to optimize the product purity and yield obtained from the described process. Only reasonable and routine experimentation will be required to optimize such process conditions.

### Methods

Proton NMR analysis was performed in deuterated chloroform using a Bruker DPX-300 NMR spectrometer.

Polymer molecular weights were evaluated by gel permeation chromatography (GPC). Polymer samples were dissolved in chloroform at approximately 1 mg/mL and were analyzed on a Viscotek GPC Max Model VE2001 system. Chromatography was performed using three Waters StyraGel (7.8×300 mm) columns: one HR2 column and two HR5E columns in series. Detection was performed by refractive index (RI). Polystyrene standards were used and analysis was performed using Viscotek OmniSEC software. Average molecular weights were reported as the weight-average molecular weight (Mw), the number-average molecular weight (Mn) and the polydisperity index (Pd). Molecular weights are reported in units of Daltons. Figures are presented showing the molecular weight distribution as a function the log(molecular weight) (figures generated by the OmniSEC software).

### Example 1

### Polymerization of 75:25 Lactide:Glycolide with Mixed Initiators 1-Dodecanol and Glycolic Acid (1:1 mole Ratio)

A two-neck flask equipped with glass stopper and inlet adapter was dried under high vacuum and nitrogen flow. The two initiators 1-dodecanol 64.6 μL (0.289 mmole) and glycolic acid 21.8 mg (0.287 mmole) were added at room temperature to the dry flask along with a 3:1 ratio of the monomers lactide 2.00 g (13.87 mmole) and glycolide 0.537g (4.62 mmole). The flask was partially lowered into an oil bath heated at 130° C. After the solid melted, 47 μl of fin(Il) 2-ethylhexanoate/toluene solution (0.2 ml of tin (II) 2-ethylhexanoate in 5 ml of toluene solution, 5.8×10⁻³ mmole) was added by pipet. The inlet adapter was removed and a glass stopper was put on. The flask was fully immersed in the oil bath. The liquid was stirred at 130° C. for 4 hours. After it was cooled to room temperature, small amount of sample was removed for NMR and GPC analysis. Results of GPC analysis are listed in Table 1.

In the ¹H NMR spectrum, the peaks at 5.1-5.3 ppm and 1.4-1.7 ppm are due to methine and methyl protons of lactide in the polymer. The peaks at 4.4-4.9 ppm are due to protons of glycolide in the polymer. The peaks at 5.1 ppm and 1.7 ppm are due to protons of lactide monomer. All glycolide polymerized, some lactide did not polymerize. The molar ratio of lactide to glycolide in the polymer is 2.4:1. The peaks at 0.8-0.9 ppm are due to methyl protons of 1-dodecanol; the peaks at 1.2-1.4 ppm are due to methylene protons of 1-dodecanol. The peaks of glycolic acid overlap with the peaks of glycolide.

### Example 2

### Polymerization of 75:25 Lactide:Glycolide with Mixed Initiators 1-Dodecanol and Methyl Glycolate (1:1 mole Ratio)

The procedure is similar to Example 1, except that methyl glycolate 22.3 μL (0.289 mmole) was used in place of glycolic acid. Results of GPC analysis are listed in Table 1.

In the ¹H NMR spectrum, the peaks at 5.1-5.3 ppm and 1.4-1.7 ppm are due to methine and methyl protons of lactide in the polymer. The peaks at 4.4-4.9 ppm are due to protons of glycolide in the polymer. The peaks at 5.1 ppm and 1.7 ppm are due to protons of lactide monomer. All glycolide polymerized, some lactide did not polymerize. The molar ratio of lactide to glycolide in the polymer is 2.6:1. The peaks at 0.8-0.9 ppm are due to methyl protons of 1-dodecanol; the peaks at 1.2-1.4 ppm are due to methylene protons of 1-dodecanol. The peaks at 3.75-3.80 ppm are due to methyl protons of methyl glycolate. Example 3:Polymerization of 75:25 lactide:glycolide with mixed initiators 1-dodecanol and methoxyPEG-OH (mPEG-2,000) (1:1 mole ratio)

A two-neck flask equipped with glass stopper and inlet adapter was dried under high vacuum and nitrogen flow. MethoxyPEG-OH 0.578g (MW 2000, 0.289 mmole) was added under nitrogen flow at room temperature. The flask was evacuated and put into an oil bath at room temperature. The oil bath was heated to 110° C. MethoxyPEG was dried under high vacuum at 110° C. for 1.5 hours. The flask was removed from the oil bath and the oil bath was heated to 130° C. The other initiator 1-dodecanol 64.6 μL (0.289 mmole) was added at room temperature to the dry flask along with a 3:1 ratio of the monomers lactide 2.00 g (13.87 mmole) and glycolide 0.537 g (4.62 mmole). The flask was partially lowered into an oil bath heated at 130° C. After the solid melted, 47 μl of fin(Il) 2-ethylhexanoate/toluene solution (0.2 ml of tin (II) 2-ethylhexanoate in 5 ml of toluene solution, 5.8×10⁻³ mmole) was added by pipet. The inlet adapter was removed and a glass stopper was put on. The flask was fully immersed in the oil bath. The liquid was stirred at 130° C. for 4 hours. After it was cooled to room temperature, small amount of sample was removed for NMR and GPC analysis. Results of GPC analysis are listed in Table 1.

In the ¹NMR spectrum, the peaks at 5.1-5.3 ppm and 1.4-1.7 ppm are due to methine and methyl protons of lactide in the polymer. The peaks at 4.4-4.9 ppm are due to protons of glycolide in the polymer. The peaks at 5.1 ppm and 1.7 ppm are due to protons of lactide monomer. All glycolide polymerized, some lactide did not polymerize. The molar ratio of lactide to glycolide in the polymer is 2.8:1. The peaks at 0.8-0.9 ppm are due to methyl protons of 1-dodecanol; the peaks at 1.2-1.4 ppm are due to methylene protons of 1-dodecanol. The peaks at 3.35 ppm are due to methyl protons of methoxyPEG; the peaks at 3.5-3.8 ppm are due to methylene protons of methoxyPEG.

### Example 4

### Polymerization of 75:25 Lactide:Glycolide with Mixed Initiators 1-Dodecanol and Ethyl Glycolate (1:1 mole Ratio)

The procedure is similar to Example 1, except that ethyl glycolate 27.3 μL (0.288 mmole) was used as initiator in place of glycolic acid. Unique protons from ethyl glycolate could not be separated out by proton NMR so no NMR spectra is provided. However, molecular weight analysis of the resulting polymer was performed by GPC and results are listed in Table 1.

TABLE 1
Molecular weight results (by GPC) for mixed-initiator
polymers (molecular weights reported in Daltons)

| Example # | Initiators | | Lot # | Mw | Mn | Pd |
|---|---|---|---|---|---|---|
| 1 | 1-dodecanol | glycolic acid | 00344-69 | 9,067 | 5,574 | 1.63 |
| 2 | 1-dodecanol | methyl glycolate | 00344-75 | 12,591 | 6,888 | 1.83 |
| 3 | 1-dodecanol | mPEG-2,000 | 00344-74 | 13,025 | 6,986 | 1.86 |
| 4 | 1-dodecanol | ethyl glycolate | 00344-67 | 15,151 | 5,677 | 2.67 |

Various modifications and variations can be made to the compounds, composites, kits, articles, devices, compositions, and methods described herein. Other aspects of the the compounds, composites, kits, articles, devices, compositions, and methods described herein will be apparent from consideration of the specification and practice of the the compounds, composites, kits, articles, devices, compositions, and methods disclosed herein. It is intended that the specification and examples be considered as exemplary.

What is claimed is:

1. A polymer mixture comprising a first polymer having a polymer backbone and one or more non-repeating units, and a second polymer having a polymer backbone and one or more non-repeating units; wherein the first and second polymer comprise a poly(cyclic ether), a poly(cyclic ester), a poly(cyclic carbonate), or a mixture thereof; wherein at least one non-repeating unit of the first polymer is different than at least one non-repeating unit of the second polymer; and wherein the polymer backbone of the first polymer is substantially the same as the polymer backbone of the second polymer.

2. The polymer mixture of claim 1, wherein if the first polymer is a poly(caprolactone) homopolymer having three or more arms, then the second polymer is not a poly(caprolactone) homopolymer having less than three arms.

3. The polymer mixture of claim 1, wherein if the first polymer is a poly(lactone) homopolymer having three or more arms, then the second polymer is not a poly(lactone) homopolymer having less than three arms.

4. The polymer mixture of claim 1, wherein the first and second polymers are linear polymers.

5. The polymer mixture of claim 1, wherein only one non-repeating unit of the first polymer is different than the non-repeating unit of the second polymer.

6. The polymer mixture of claim 1, wherein the first polymer has a non-repeating end group comprising an ester, and the second polymer has a non-repeating end group comprising a carboxylic acid.

7. The polymer mixture of claim 1, wherein the first or second polymer is poly(lactide), poly(glycolide), or poly(lactide-co-glycolide).

8. A method for making a polymer mixture, comprising:
a) providing a monomer composition comprising a cyclic ether, a cyclic ester, a cyclic carbonate, or a mixture thereof; and
b) contacting the monomer composition with at least two initiators comprising a first initiator and a second initiator that is different from the first initiator under reaction conditions effective to form the polymer mixture.

9. The method of claim 8, wherein if the monomer composition comprises caprolactone, and if one initiator comprises three or more functionalities that are capable of initiating a polymerization in the monomer composition, then the other initiators do not comprise a mono- or di-functional initiator capable of initiating a polymerization in the monomer composition.

10. The method of claim 8, wherein if the monomer composition comprises a lactone, and if one initiator comprises three or more functionalities that are capable of initiating a polymerization in the monomer composition, then the other initiators do not comprise a mono- or di-functional initiator capable of initiating a polymerization in the monomer composition.

11. The method of claim 8, wherein the initiators all independently have one functionality capable of initiating a polymerization in the monomer composition.

12. The method of claim 8, wherein the monomer composition comprises only one monomer type.

13. The method of claim 8, wherein the monomer composition comprises at least two monomer types.

14. The method of claim 8, wherein the monomer composition comprises lactide, glycolide, or a combination thereof.

15. The method of claim 8, wherein the first and/or second initiator comprises one or more of water, a hydroxyl acid, an alcohol, an amine, or a thiol.

16. The method of claim 8, wherein the first and/or second initiator comprises one or more of water, 1-dodecanol, hexane diol, lactic acid, glycolic acid, methyl glycolate, ethyl glycolate, or a combination thereof.

17. The method of claim 8, wherein the first and second initiator comprises one or more of 1-aminohexane, 1,6-diaminohexane, glycine, or arginine.

18. The method of claim 8, wherein the first and second initiator comprises hydroxyl terminated poly(ethylene glycol) (PEG) and an alcohol.

19. The method of claim 8, wherein the first and second initiator comprises hydroxyl terminated poly(ethylene glycol) (PEG) and water.

20. A polymer mixture formed by the method of claim 8.
